(19) United States
(12) Patent Application Publication
(10) Pub. No.: US 2003/0208440 A1
(43) Pub. Date: Nov. 6, 2003

(54) International payment system and method

(76) Inventors: Robert Harada, Emerson, NJ (US); Leigh Malnati, Mountain Lakes, NJ (US); Stephen J. Flett, Fairfield, CT (US)

Correspondence Address: John G. Bisbikis, McDermon, Will & Emery, 227 W. Monroe Street, Chicago,, IL, 60606-5096, US

(21) Appl. No.: 09/846,880

(22) Filed: May 1, 2001

Related U.S. Application Data
(60) Provisional application No. 60/201,025, filed on May 1, 2000.

(51) Int. Cl. G06F 17/60

(52) U.S. Cl. 705/39

(57) ABSTRACT

An international payment system, where a payment instruction is communicated from a customer in one country to a local currency account in another country. A payment is then provided from the local currency account to a destination/beneficiary account of an intended beneficiary. Separately, a payment request is communicated to a funds account to ensure that sufficient funds to cover the payment are provided to a treasury account. The funds at the treasury account may be exchanged for the foreign currency of the local currency account, and payment made to the local currency account either by transferring funds directly to it, or by providing a credit entry in a general ledger on behalf of the local currency account in the first country. The system enables direct access to transaction status information at the local currency account. A customized international payment transaction user interface is also provided.

This application claims the benefit of U.S. Provisional Patent Application No. 60/201,025, filed May 1, 2000, titled “International Payment System and Method”.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

International payment systems transfer currencies and payment information across national borders. For example, an international payment system can be used to effectively transfer money from an originating account in one country to a destination account in another country. Furthermore, the originating account and destination account may be owned by different parties, may be denominated in different currencies, may be different types of accounts, or may have a variety of other differences.

Information technology has been used to streamline and automate transaction processing in many modern international payment systems, however current approaches still require the use of a complex network of intermediary financial institutions such as correspondent banks and clearing houses to accomplish an international payment. Because of the structure and complexity of current systems, there are several inefficiencies and delays inherent in international payment systems.

In a typical international payment transaction, a customer transfers money from a source account in one country to a destination account in another country. The source account is typically held by a local institution which may be a local bank, a local branch of a national bank, or other locally accessible financial institution. When the customer orders an international payment transaction, the order is initially placed at the institution holding the customer's source account. The source financial institution typically has a relationship with a correspondent bank, Regional Clearing House, or other financial institution. The corespondent bank or Regional Clearing House, in turn, has direct relationships with other banks and financial institutions in the destination country, and can provide additional services such as currency exchange transactions and account verification. A similar network of relationships usually exists in the destination country, thus creating a chain of financial institutions from the local institution where the payment originates to the institution in the destination country where the beneficiary's account is located.

Many financial institutions utilize the SWIFT system to execute international financial transactions. SWIFT is an international financial communications network that provides a secure payment and messaging protocol. SWIFT, or Society for the Worldwide Interbank Funds Telecommunications, based in Belgium, is an industry owned co-operative supplying secure messaging services and interface software to financial institutions in many different countries. Each institution on the SWIFT network is assigned a unique SWIFT identification number, which is used as a message address to authenticate transactions by designated recipients. Authorized parties create SWIFT payment messages, which are then sent across the SWIFT network to accomplish a variety of financial transactions including international payments. The SWIFT payment message typically traverses several financial institutions through the SWIFT network to reach its ultimate destination.

The use of multiple financial institutions to accomplish the execution of international payments has several inherent inefficiencies. For example, international payments must currently go through a settlement process that typically takes two business days for transactions that involve more than one currency. There is also a time delay as the international payment message is processed by the various financial institutions on the SWIFT network. Furthermore, customers incur added transaction fees to utilize the resources of these institutions.

Another limitation of current international payment systems is the inability to comprehensively monitor payment transactions. For example, on the SWIFT system once a payment message is transmitted, the local bank that originated the payment message loses control over it. In order to determine the status or location of a payment in the SWIFT network, the originating bank must query the first external institution along the chain of transmission. If the payment message has already been processed by the first external institution and forwarded on to another financial institution then the status request message is forwarded along the same route as the payment message that preceded it. This process is repeated to determine the location and status of the payment and message in the international payment chain. Thus, in order to determine the status of a prior transaction, the status request message transmitted by the local bank must traverse the same path as the payment instruction message, which is determined by querying each bank on the route traversed by the payment instruction message. Investigations into the status of payment transactions are therefore slow and inefficient. Moreover, because current systems do not automatically process certain status request messages, investigations can be delayed for days or weeks while each institution processes and forwards the status request message.

Thus, there is a need for an international payment system that eliminates inefficiencies caused by intermediary banks and financial institutions. There is also a need for an international payment system that automatically processes most or all of the steps of an international payment transaction. Furthermore, there is a need for an integrated system that provides improved status information such as real-time monitoring of international payment transactions.

### SUMMARY OF THE INVENTION

Generally, the present invention is a system and method for ordering, pricing, processing, and executing international payment transactions. More specifically, the invention is directed to a system and method for moving funds from a source account in one country to a destination account held in another country, thus bypassing the traditional international settlement system and associated inefficiencies. The present system and method is designed to accommodate all types of financial accounts and financial instruments, and enables institutions, such as banks, as well as individual customers to efficiently execute international payment transactions.

One object of the present invention is the automation of the international payment process.

Another object of the present invention is to eliminate intermediary financial institutions and bypass traditional foreign exchange settlement methods.

Another object of the invention is increased flexibility in payment execution.

Another object of the invention is increased payment execution speed.

Another object of the invention is the ability to more effectively track the execution of international payments.

In one aspect of the invention, a method is provided for making an international payment from a source account in a first country to a local currency account in another, second country. In the method, a payment instruction and a payment request that are associated with a common transaction request are created. The payment instruction is communicated to the local currency account in the second country, and designates a beneficiary account in the second country to which the local currency account transfer currencies. The beneficiary account, which may sometimes be referred to herein as a destination account, may either be the account for the bank or other financial institution at which a customer or end recipient holds an account or the end recipient's account itself.

The payment request is communicated to a funds source associated with the source account. In accordance with the payment request, funds are transferred from the funds source to a treasury account if necessary to maintain a balance at the treasury account which is sufficient to cover an amount of the payment request. Moreover, funds at the treasury account are used to provide a payment to, and/or credit entry on behalf of, the local currency account in a currency of the second country.

### BRIEF DESCRIPTION OF THE DRAWINGS

The invention is illustrated in the figures of the accompanying drawings that are meant to be exemplary and not limiting, in which like references are intended to refer to like or corresponding parts, and in which:

FIG. 1 is a block diagram of the order taking and validation process of one embodiment of the present invention;

FIG. 2 illustrates a conventional international payment system;

FIG. 3(a) is a block diagram depicting a payment transaction system in accordance with one embodiment of the present invention;

FIG. 3(b) is a block diagram depicting an alternative payment transaction system in accordance with the present invention;

FIGS. 4(a) and 4(b) are block diagrams of one embodiment of the reconciliation process of the present invention; and,

FIG. 5 is a block diagram of one embodiment of a payment instruction transmission in the present invention.

### DETAILED DESCRIPTION OF THE INVENTION

Embodiments of the present invention will now be described in detail with reference to the accompanying figures.

I. Customer Verification and Approval

Customers wishing to execute international payments may first enroll with the service and obtain a configured account within the system. Customers may include persons, businesses, financial institutions, transaction aggregators or other entities who enroll with the service. The system may be accessed via the Internet. Alternatively, the system may be accessed via some other wide-area network, local area networks, wireless information appliance, telephone/cell phone, personal digital assistant, or any other data communications system. The preferred embodiment of the system may be accessed through a web-based user interface. The preferred embodiment also accepts direct inputs from an external computer system which may transmit a transaction file via an established communication interface.

Upon accessing the system for the first time, a new customer file is generated, and stored in a system database containing profile information on all customers. A prospective customer completes a questionnaire, which is then processed. After all information provided by the prospective customer is initially reviewed for accuracy and completeness, advanced checks may be performed. For example, such checks may include reviews required by Federal Regulations, such as OFAC, and date-of-birth to Social Security number cross-referencing, to ensure that a prospective customer is not fraudulently representing their identity or background. The Office of Foreign Assets Control (“OFAC”) of the U.S. Department of the Treasury administers and enforces economic and trade sanctions against certain foreign countries. Provided that the prospective customer passes these checks, application processing will continue.

After the initial checks are completed, the prospective customer may list accounts from which funds will be drawn when the requested international payments are executed. Accounts from which to draw funds include, but are not limited to, checking and savings accounts, money market accounts, debit accounts, credit and charge accounts, other third party lines of credit, and other financial products or investment instruments that may be represented electronically. After the prospective customer has listed accounts to withdraw from, the system will electronically communicate with each institution listed to verify account information. Optionally, the system may also communicate with a credit-reporting bureau to obtain credit data regarding the prospective customer. This data will factor into the decision of whether or not to approve the new account. The credit information may be accessed, and manually keyed in and held by the system.

Once the new application file is processed and approved, it is assigned a unique identifier by which the file can be referenced when the customer returns. The file is then written to a table within the system database. Each time the customer accesses the system, the file will be retrieved by the system in order to customize the interface with the data contained therein. Such an interface may include an on-screen graphical user interface that provides information regarding the customer's activities, as well as input fields for entering information via an input device such as a keyboard, mouse or the like. This provides a personalized international payment transaction environment.

The customer may now identify beneficiaries to whom payments are to be made. Beneficiary information may include, but is not limited to, identification information and bank information. When the need to add new beneficiaries arises, the customer may access a subsystem or module that includes functionality to add this information. This information is then stored in a beneficiary file in the system database and is related to the customer file by the customer's identification number.

Additionally, data regarding customer transactions are written to a transactions file. Depending on various factors, such as the monetary value and frequency with which transactions are executed, the system will calculate an exchange rate markup to be applied to transactions. For example, if a specific customer executes one transaction per month for a value within a predetermined threshold range, the system may compute a personal markup rate of 2%. Customers that make frequent large transactions may be charged a lower rate, while relatively small, single-event transactions may incur higher transaction charges. Transaction data is also utilized by the system to conduct investigations, create audit logs, and view transaction status information. Like beneficiary information, this data is related to the customer file via the unique customer identification number.

After approval, when the customer subsequently logs on, the system will query its database to retrieve the customer's profile data that was collected during the registration process. The system initially presents the customer with an interface that may include options to execute new transactions, add or modify beneficiaries. These options are representative and new options may be added or substituted.

II. Order Taking

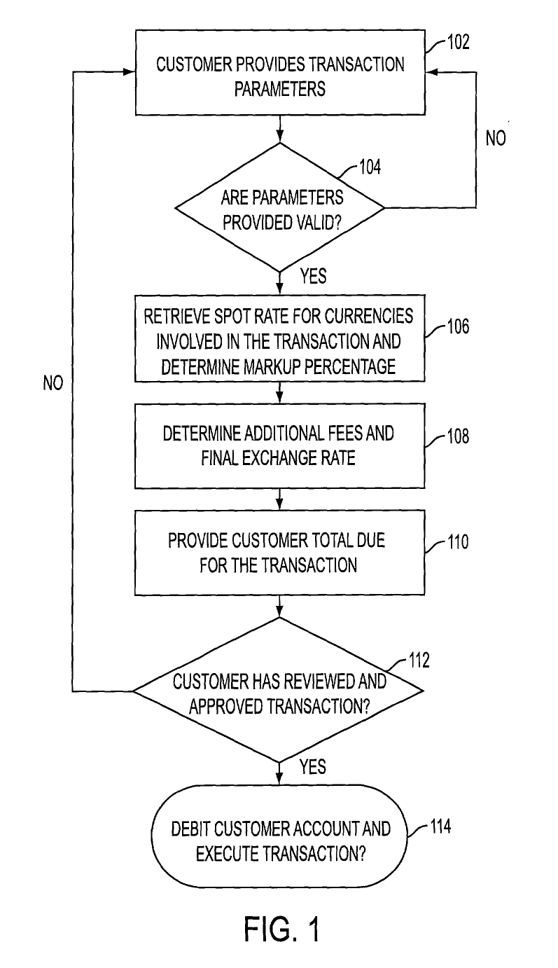

Referring to FIG. 1, a flowchart describes the process executed by the system to place a customer's international payment order. The first step in the process of executing an international payment as contemplated by the invention is for the customer/client to provide various parameters for the transaction 102. These parameters include the intended beneficiary, the dollar amount of the transaction, the currency that the payment is being made with, the customer account to make the payment from, and the type of financial product involved. Upon receiving the transaction data, the system will validate it 104 and calculate the exchange rate that will be offered to the customer.

An internal table or matrix is used to determine the appropriate exchange rate and associated exchange transaction markup. In this table, currency types are stored in one dimension of the table while different rates corresponding to different transaction sizes or types are stored in other dimensions. Thus, any specific rates and associated transaction markups may be determined immediately by looking up the source currency, destination currency, and transaction characteristic. Alternately, the system will dynamically determine the spot exchange rate through an external foreign exchange information service, for example, Reuters. The total transaction cost to the customer will typically include both an exchange purchase at the spot rate plus applicable markups. The spot rate and markup fees are determined in step 106, and other fees and charges are added in step 108.

The customer receives information regarding all the elements of the transaction for a final review before it is executed 110. Of particular importance is the total amount and currency denomination to be paid to the beneficiary, the total amount and currency the customer is using to fund the transaction, the actual exchange rate used, any additional fees that may be due, and the total charges to the customer. However, if a customer is using a non-interactive or batch process, the system will not confirm the final rate to the customer until the payment has been processed. For example, if the system is connected into an accounts payable system, it can receive a batch of transactions, process them, and then will return a batch file after the transactions have been initiated with transaction confirmation details.

After the customer has reviewed and approved the transaction 112, the system queries the institution holding account that has been selected to fund the payment. Provided there are sufficient finds in the account to fund the payment, the system will debit the customer's account and execute the outgoing payment 114.

III. Outgoing Payment Execution

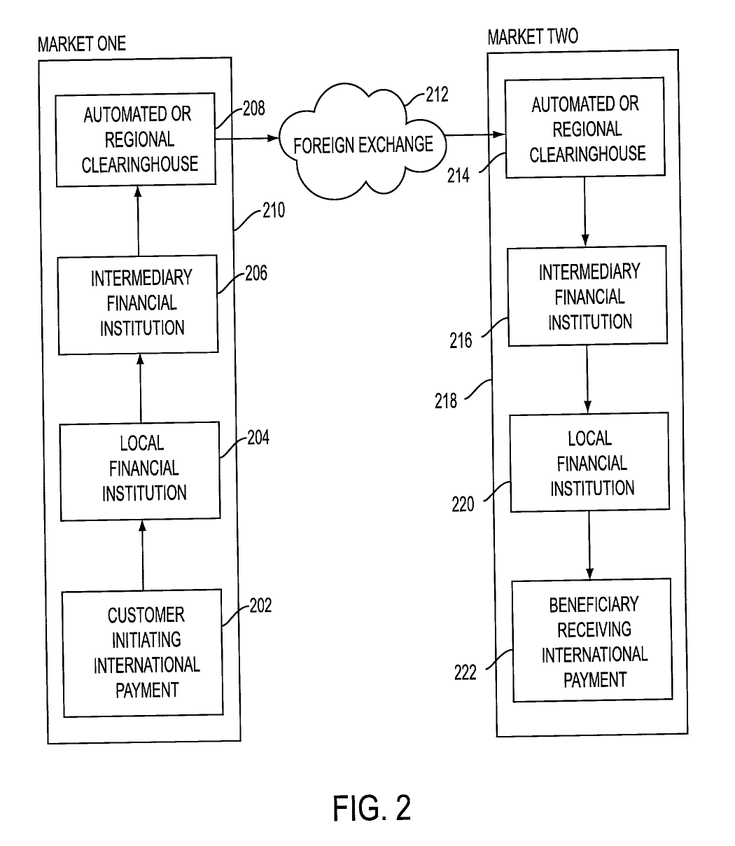

FIG. 2 represents a conventional international payment system structure. Current systems typically utilize a network of correspondent banks to move money from a customer to a beneficiary. These correspondent banking transactions can be viewed as a series of credits and debits, starting at the originating bank and ending at the destination bank, where the originating bank is in a first market 210 that may be one country and the destination bank is in a second market 218 that may be in another country. Here, the customer initiating the payment 202, places an order with a local financial institution 204 which holds the customer account. The local financial institution 204 then executes a transaction with an intermediary financial institution 206 whereby a credit is transferred to the intermediary institution 206 while the customer account in the local institution 204 is debited. This process is continued as the intermediary financial institution 206 then executes a financial transfer with an automated or regional clearinghouse 208. The clearinghouse 208 executes a foreign currency exchange transaction 212. Once the transaction amount has been exchanged, a financial transfer is executed with a regional or automated clearinghouse 214 in the destination country. From the destination clearinghouse 214 a transfer is made to an intermediary financial institution 216 in the destination country, and another transfer is made to the local financial institution 218 that may be access by the beneficiary receiving the international payment 222. This chain of transactions thus constitutes the typical steps in a traditional international payment transaction.

By contrast, the present invention sends payment instructions independently of the actual monetary transfer, which eliminates the need to execute the chain of credits and debits between correspondent financial institutions. Thus, added transaction time and overhead created by traversing a chain of intermediary institutions, and conducting foreign exchange transactions is removed.

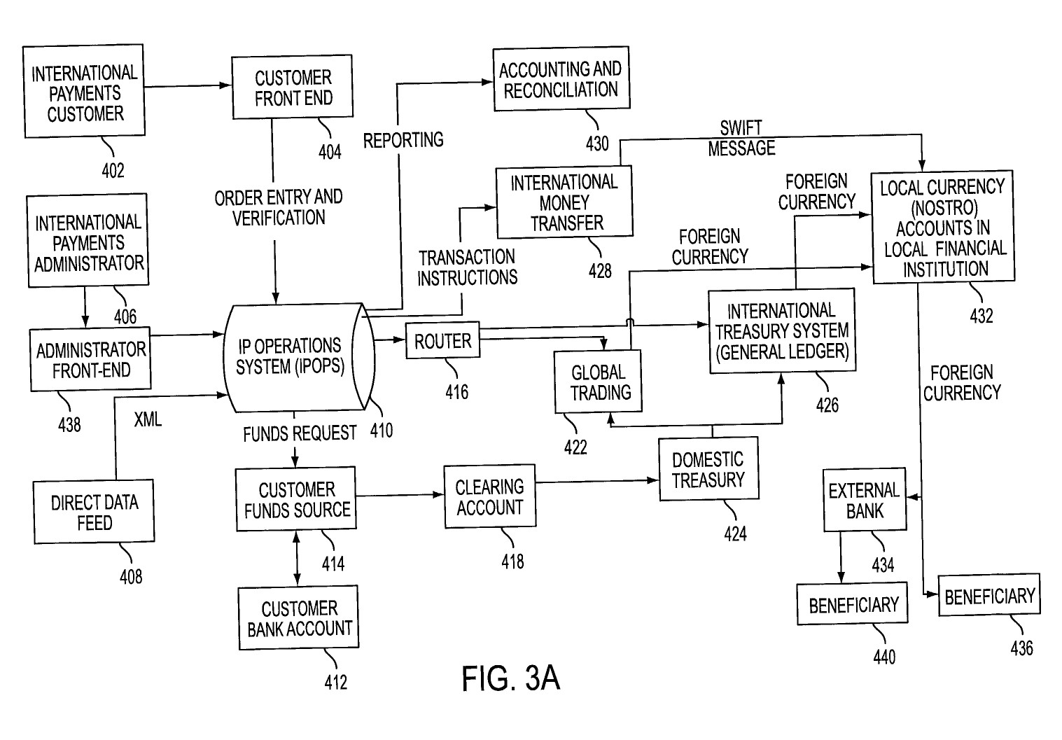

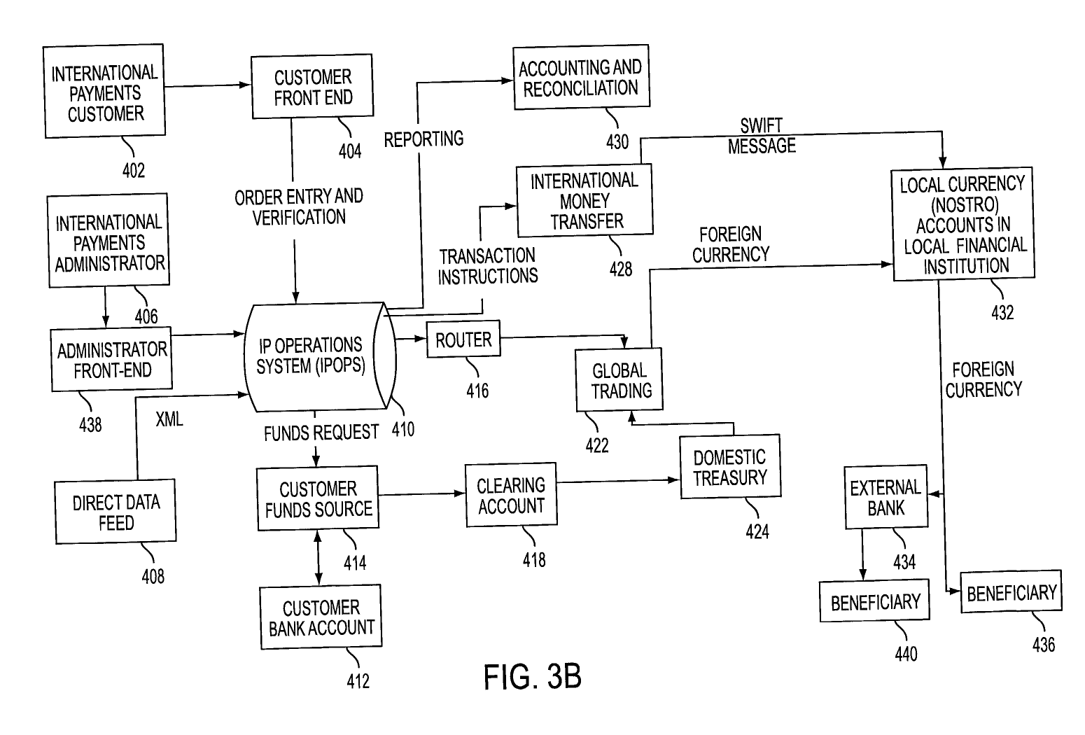

FIG. 3(a) presents a block diagram of one embodiment of the present invention. In the preferred embodiment of the present invention, payment requests may be initiated by an international payments customer 402 who may be operating an international payments customer front end system 404. Payment requests and other status or configuration information may be also entered by an international payments administrator 406 operating an administrator front end 438 that links directly to the International Payment Operations (IPOPS) system 410. A third mechanism for accessing the system is also provided where a direct data feed 408 is provided into the system. Through the direct data feed into the system, an external institution, electronic marketplace, or other transaction aggregator can transmit a data file with one or more international payment requests.

The IPOPS system 410 processes the input data and may execute international payment transactions based on the input data. In one possible configuration, two types of international payment transactions are implemented. The transaction type is determined by a transaction router 416 that may take into account the size of the payment transaction, the risk profile of the transaction, or other criteria to determine the appropriate transfer route for the transaction. The risk profile may relate, e.g., to the soundness of the originating financial institution and/or country. In one routing option, the transaction is routed to a global trading system 422 where the currency from the funds source 414 is traded (converted) to the local, foreign currency of the account 432, and may be hedged. Alternately, the transaction may be routed to a General Ledger within an International Treasury System 426. Such an international treasury may include a multiple currency general ledger system. Generally, for larger and/or riskier transactions, it may be preferably, at least from the perspective of the local currency account 432, to trade the currency from the funds source 414 to the local foreign currency and transfer it to the local currency account 432. For smaller and/or less risky transactions, an entry in the general ledger may be used.

FIG. 3(b) illustrates an alternative payment transaction system in accordance with the present invention. Here, the International Treasury System is eliminated, and all transactions are routed to a global trading system 422.

With this approach, the International Treasury is eliminated from hedging and funding smaller transactions, such as those under $25,000. A banking entity, such as American Express Bank Global Trading, may hedge and fund all transactions regardless of size. In this case, all internalized payment orders, regardless of the amount, are handled through a Treasury of the bank, such as American Express Bank Treasury. The bank funds the local currency (Nostro) bank accounts 432 relevant to the trades (payments). The bank may prepare a report at end of day reflecting all the trades made on that day. This is to confirm the trades and is also used as a control tool. The IPOPS 410 transactions instructions to the bank 428 which converts the instructions into a SWIFT message for transfer to the local currency accounts 432. Thus, all the transactions are booked and traded through the bank.

Advantages of this approach include improved revenue by getting away from the card authorization system buy rates. Additionally, there is an extended cut-off time for payment processing on a daily basis. There is no need to adhere to intercompany accounting system cutoff time. Finally, there is an improved reconciliation and payment investigation process by minimizing resolution turnaround time. Regardless of the route selected for the actual currency payment, the transaction instruction is transmitted to the international money transfer system where a message, such as a SWIFT message, is transmitted to the local currency (Nostro) account at the local financial institution 432. A Nostro account is a bank account conducted by a bank with a bank in another country, usually in the currency of that country. From the local accounts 432 foreign currency may be transferred directly to a beneficiary account 436, or may be routed onward to an external bank 434, then transferred to an external beneficiary account 440.

Currency transfers for both routing scenarios are accomplished by sending a funds request from the IPOPS system 410 to a customer funds source 414. The customer funds source draws from the customer's bank account 412. Customer funds are transferred from the customer funds source 414 to a clearing account 418 and are then transferred on to a domestic treasury account 424. Depending on the routing method selected for the funds transfer, the currency may be transmitted to a global trading system 422 (possibly through a router 416) where the funds may be directly exchanged. Alternately, the funds are transmitted from the domestic treasury account 424 to the international treasury general ledger system 426. Entries in the international treasury general ledger system 426 are then made that correspond to the intended transaction. As transactions are conducted, an accounting and reconciliation system 430 is periodically executed.

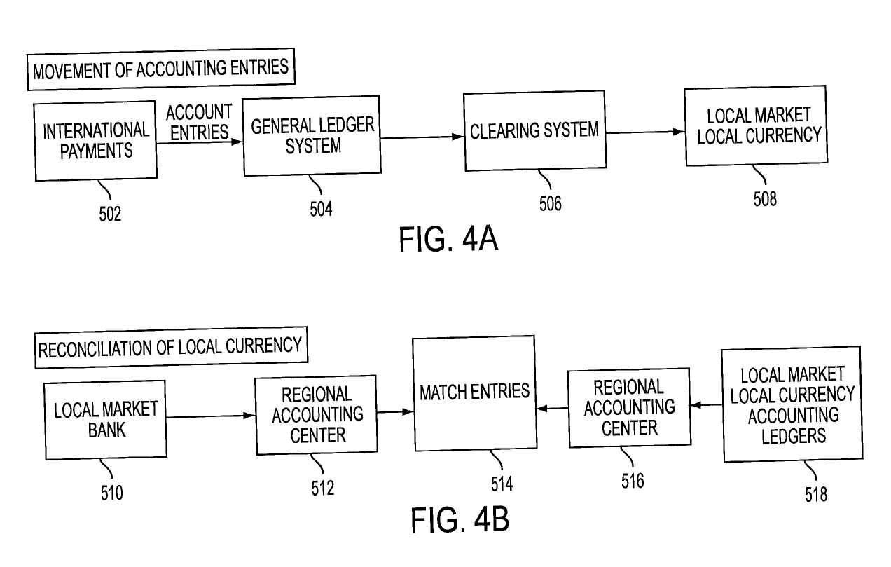

FIG. 4(a) shows a block diagram of a generalized reconciliation process that is implemented by moving accounting entries in the general ledger that correspond to an international payment. Here, the international payments system 502 transmits one or more accounting entries to the general ledger system 504, which documents and effectively executes the transaction immediately. The general ledger system in turn connects to an internal clearing system 506. At the final step, funds are transferred from the clearing system 506 to the local market where they are recorded as an accounting entry, in this case a credit, in the general ledger system 504. Thus, the payment transfer is essentially accomplished by making accounting entry modifications in the general ledger.

FIG. 4(b) shows a block diagram of a generalized reconciliation process that is implemented by matching or offsetting accounting entries in two different local markets. Here, a local market bank 510 transmits account change information to a regional accounting center 512. In parallel with this process, local market accounting ledger entries 518 are sent to a regional accounting center 516. In block 514, these entries are matched or offset against each other, so that where possible credits are debits are used to cancel each other out.

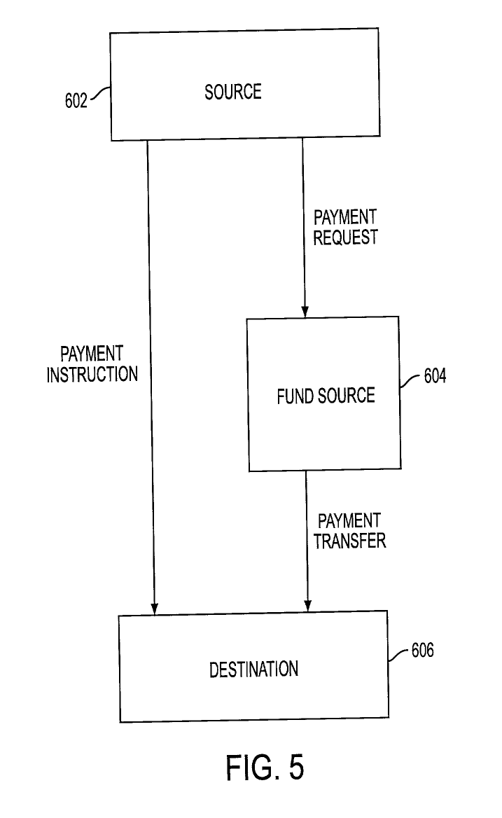

FIG. 5 shows a block diagram of a generalized payment message transaction. Here, a payment source 602 transmits a payment instruction directly to a destination account 606. This payment instruction does not involve the actual movement of currency, but instead directs the movement of accounting entries in the destination account system 606. Independently of the payment message transmission, a payment request is transmitted directly to a fund source 604, which may be a general ledger system or a trading system as described above. Funds are then transferred, when necessary, from the funds source 604 to the destination 606. Such funds transfers will only be required when there are not sufficient credits to offset incoming debits (in the case of debit transfers), or where there are not sufficient debits to offset incoming credits (in the case of credit transfers).

The invention has access to a worldwide framework of bank accounts located in markets throughout the world. Each account is funded with local currency that is ultimately used to make payments to beneficiaries. After a customer enters an order and all markups and fees are applied, an electronic message is generated that contains only payment instructions but not an actual payment transfer of currency. This payment instruction message is passed through a subsystem that validates the contents of the message before it is transmitted. The instruction message is transmitted on the SWIFT network as a SWIFT message in the preferred embodiment, but any financial interchange network or messaging system may be used.

Transaction speed is improved by removing the payment portion from the SWIFT message that is sent to the destination institution. Instructions are sent to move currency from the system's account in the destination market into the destination beneficiary's account. Since payment instruction is being transmitted solely and directly to the institution holding the account of the System in the destination market, the message arrives at the foreign bank nearly instantaneously. The result is that beneficiaries receive payments faster by bypassing the foreign currency settlement process. The system may then settle the foreign exchange portion of the transaction. This may occur, e.g., the same or next day, or at another future time.

Moreover, using native finds already located in the destination market allows payments to be made without a foreign exchange transaction to convert the funds from the originating currency to the destination currency. Thus, the volume and speed at which transactions may be executed is limited only by the amount of funds held in destination accounts and the availability of currency on local markets. Given the use of Nostro accounts, adequate foreign currency is usually available.

Furthermore, note that the system allows for flexibility in currency pairs. This enables the system to support payments from any source currency to any destination currency. Thus, the system is truly global because transactions may be made directly between any two currencies without requiring an intermediary currency and without relying on any one standard currency.

The system supports interfaces into a variety of customer funding methods. For example, the payment may be drawn against a bank account or line of credit. Moreover, a credit card or other funding source may be used.

The system allows for holding payments or timing payment executions. Held payments can be used for a variety of purposes escrow arrangements. Timed payments may be triggered to execute on a specific date or may include regularly scheduled payment transfers.

The system provides automated links to enable payment instruction processing by banks that hold accounts within the system. Accounts within the system that are located in remote locations or at other institutions are also called Nostro accounts.

It should also be noted that the present system may also be used as a link in a correspondent system and not just as an end-to-end payment system. For example, if the destination account in an international payment is not included within the system, the payment can be routed to the Nostro account that is closest to the destination account. Typically, this would be a Nostro account in the same destination country as the destination account, or the Nostro account with a direct correspondent relationship with the institution that holds the destination account. The final transfer from the destination Nostro account to the destination account would then take place through a traditional payment transfer, such as via a correspondent relationship. Thus, the system can interface directly with a variety of external systems, such as bank systems, e-commerce marketplaces, aggregators, escrow providers, accounts receivable systems, account payable systems, and other systems.

Because the system has access to funded accounts throughout the world, intermediary financial institutions are not required to execute payments in destination markets. This eliminates the need to use traditional foreign exchange transactions, such as described in FIG. 2, when making payments to beneficiaries. Even where large banks with branches in different countries conduct business as if they were separate legal entities, the present system provides a more direct financial interchange without the need for intermediaries. Thus, instead of passing funds through multiple intermediate entities, the system utilizes local currency accounts that already exist in the destination markets. Of course, where the final transfer is to an institution that is not integrated into the system, the last step or steps in the transaction may be routed through other financial institutions. This allows services to be provided to any financial institution and also allows the use of special function financial institutions where requested.

IV. Foreign Exchange

Employing current systems, a foreign exchange transaction must purchase the required amounts of destination currency when an international payment is made that requires different source and destination currencies. For example, if an account containing U.S. Dollars is used to make an international payment to an account containing Japanese Yen, the appropriate amount of Japanese Yen must be purchased through a currency exchange transaction. In the above currency transaction example, the U.S. Dollars would be used to purchase the Japanese Yen.

In the present system, there is no need for a currency exchange transaction for each international payment. This is because the system makes payments to beneficiaries using funds already held in the destination market. After the party initiating the transaction makes a payment to the system and the beneficiary receives the payment from the system in local currency, the destination accounts managed by the system must be reimbursed with currency native to the destination market. There are several alternative methods of obtaining the requisite destination currency for the transaction.

One method for obtaining the requisite destination currency is to accumulate several transactions that involve the same currencies. For example, if there are ten transactions that each involve payments from U.S. Dollar accounts to Japanese Yen accounts, then the U.S. Dollar amounts may be accumulated to purchase the Japanese Yen required for all of the transfers. This simplifies the currency exchange transaction, reduces transaction fees, and may produce better exchange rates through economies of scale.

Another method of obtaining the currency necessary to fund the destination accounts is to create a forecast. A forecast is a prediction of the currency needs of the system for each of the accounts it holds in the destination markets. For example, the system might take a 90-day rolling average to determine the amount of currency to purchase on a particular day; utilizing data regarding what has happened on the previous day to determine what to do on the present day. The rolling average may be calculated by the system on a daily basis to continuously update its positions.

Currency transactions may be ‘floated’ or timed to obtain better exchange rates where possible. The system accomplishes this by taking positions in various currencies. The system holds money given to it by the transaction initiator and decides, based on its world currency positions, whether it should hold on to the funds it has or convert them to destination currencies to replenish its destination accounts. By analyzing exchange trends on world markets for various currencies, the system can determine when to execute a currency exchange transaction to receive the best rate possible. Thus, aggregating many small transactions and floating the accumulated sum to achieve a maximum exchange rate allows the process of settling international payments to be re-marketed to consumers. The system provides enhanced services to customers and allows the system to generate sustained revenues by eliminating intermediary external financial institutions and receive the most favorable rate when exchanging currencies.

It should be noted that while currency exchange transactions may be deferred, floated and otherwise optimized, the customer is provided with a spot rate quote that is valid for current transactions. The provided spot rate quote, of course, may not be the actual rate that is applied to the underlying currency exchange transaction, because the actual currency exchange transaction may be done at a different time, either later or earlier, than the spot rate quote. The spot rate quote may be stored within the system for rapid access, or the spot rate may obtained from a data feed, a query to determine an appropriate currency exchange rate, or through other methods for deriving the spot rate quote. The system thus provides dynamic real-time pricing, including spot rate quotes, for all transactions. This permits customers to know the precise details, including currency transaction rates and all associated costs, related to their selected payment transaction.

V. International Payment Operations (IPOPS)

Another significant benefit of the transaction processing system of the present invention is the ability for customers to track their international payments, potentially in real time. As stated above, messages containing only payment instructions are passed through the SWIFT network, which arrive nearly instantaneously at the institutions in the destination markets where the system has access to accounts. Where the system has direct access to foreign or other accounts, such as when a common organization controls the accounts, it will query these accounts directly to determine status information. Generally, obtaining account status information can be accomplished where access to the accounts is available and standardized data formats are used, as will be appreciated by those skilled in the art. In the exceptional situation where there is an additional transfer to an external financial institution, such as where the beneficiary account is held in an institution not within the system, then the query is forwarded onward to that external financial institution.

Traditionally, when a customer requests the status of a payment using current systems, each institution along the path of the message must be traversed to determine the institution currently in holding the payment message. Using the present invention, however, the system has direct access to information regarding transaction status at the local currency account.

Here, when the account is held internally (e.g., by a common controlling organization), the system simply makes an direct query that returns current payment status information. When the account is held in an external account a message is sent to the external institution that holds the account for status information.

Customers accessing the system may choose a ‘transaction history’ option from the initial login interface. This first causes the system to retrieve information regarding transactions from the customer's transaction data file. This information concerning past and current transactions is then presented to the customer in a clear, organized and unified fashion. Thus, by utilizing the present invention, customers have expanded access to payment status in addition to greater speed in executing transactions.

VI. Other Features

The preferred embodiment of the system is a web-based application. The web application includes a front-end portion that provides interaction with the customer, error checking and feedback, a help system, and other user interface features. The system also has a browser interface that allows it to be used on a number of computing platforms made by different manufacturers. Furthermore, the web interface allows the system to be used from any physical location that has access to the Internet.

The system can support customized front-end interfaces, thus allowing international customizations such as providing system interfaces in different languages, and providing appropriate default base currencies for transactions. Moreover, multiple front-ends, each configured for different purposes or markets, can be concurrently routed into the system.

The system may be configured and individualized for each customer. For example, the system supports customized fee schedules for each customer. The system also supports customized currency transaction rate schedules by customer. This allows exchange rate mark-ups to vary by customer, currency type, the size of the transaction, or other factors.

Security may be tightly integrated into the system, where various security features are provided in different parts of the system. For communication between computing hosts and for certain data storage requirements, the system provides advanced encryption technology. Customers and system operators may specify and use access privileges to protect data. For example, one user may only be permitted access to a subset of the information or transactions available on the system. A hierarchical verification paradigm, including dual verification for individual transactions, may be applied for control purposes on both the internal processing (IPOPS) and customer (web-front end) side.

The system provides audit, compliance and tracking information on payment transactions. For example, the system includes compliance (e.g., OFAC) checking on every payment. The system also provides Management Information System (MIS) reporting on transactions for compliance purposes, including the detection and prevention of money laundering.

Accordingly, it can be seen that the present invention provides an international payment system, where a payment instruction is communicated from a customer/user in one country to a local currency account in another country. A payment is then provided from the local currency account to a beneficiary account of an intended beneficiary. Separately, a payment request is communicated to a funds account to ensure that sufficient funds to cover the payment are provided to a treasury account. The funds at the treasury account may be exchanged for the foreign currency of the local currency account, and payment made to the local currency account either by transferring funds directly to it, or by providing a credit entry in a general ledger on behalf of the local currency account.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for making an international payment from a source account in a first country to a local currency account in another, second country, comprising:
creating a payment instruction and a payment request that are associated with a common transaction request;
communicating the payment instruction to the local currency account in the second country;
wherein the payment instruction designates a beneficiary account in the second country for the local currency account to transfer currency to; and
communicating the payment request to a funds source associated with the source account; wherein:
in accordance with the payment request, funds are transferred from the funds source to a treasury account if necessary to maintain a balance at the treasury account which is sufficient to cover an amount of the payment request, and funds at the treasury account are used to provide at least one of: (a) a payment to, and (b) a credit entry on behalf of, the local currency account in a currency of the second country.

2. The method of claim 1, wherein:
the payment to the local currency account is provided by exchanging the funds at the treasury account for the currency of the second country, and transferring the exchanged funds to the local currency account.

3. The method of claim 1, wherein:
the credit entry is provided by exchanging the funds at the treasury account for the currency of the second country, and making a credit entry for the exchanged funds in a general ledger on behalf of the local currency account.

4. The method of claim 1, wherein:
the communicating of the payment instruction to the local currency account is independent of the communicating of the payment request to the funds source.

5. The method of claim 1, wherein:
the funds source draws from the source account.

6. The method of claim 1, wherein:
the payment instruction identifies at least one of: a currency type of the first country, the source account, and a type of financial product associated with the transaction request.

7. The method of claim 1, wherein:
the payment instruction and the payment request are created via user inputs to a computer-generated interface.

8. The method of claim 1, further comprising:
validating transaction data associated with the payment instruction prior to communicating the payment instruction to the local currency account.

9. The method of claim 1, further comprising:
determining an exchange rate to offer to a user that creates the transaction request for approval thereby prior to communicating the payment instruction to the local currency account;
wherein the providing of the payment to, and/or credit entry on behalf of, the local currency account, is responsive to the exchange rate.

10. The method of claim 9, where in:
the user is enabled to create the transaction request using a computer system; and
the exchange rate is determined using data that is stored locally to the computer system.

11. The method of claim 9, wherein:
the user is enabled to create the transaction request using a computer system; and
the exchange rate is dynamically determined through an external foreign exchange information service.

12. The method of claim 1, further comprising:
querying the funds source to determine if there are sufficient funds thereat to fund the payment request.

13. The method of claim 1, further comprising:
debiting the source account according to the amount of the payment request.

14. The method of claim 1, wherein:
the currency of the local currency account is transferred directly therefrom to the beneficiary account without passing through an intermediary financial institution.

15. The method of claim 1, wherein:
the currency of the local currency account is transferred therefrom to the beneficiary account via at least one intermediary financial institution in the second country.

16. The method of claim 1, wherein:
the local currency account comprises a Nostro account.

17. The method of claim 1, wherein:
the payment is provided to the local currency account in lieu of providing the credit entry on behalf of the local currency account according to the amount of the payment request.

18. The method of claim 1, wherein:
the payment is provided to the local currency account in lieu of providing the credit entry on behalf of the local currency account according to a risk profile associated with the payment request.

19. The method of claim 1, wherein:
the funds from the funds source are transferred to the treasury account via a clearing account.

20. The method of claim 1, wherein:
the payment instruction is communicated to the local currency account in the second country via a financial interchange network.

21. The method of claim 1, further comprising:
enabling tracking of the transaction request by a user.

22. The method of claim 1, wherein:
enabling a user to create the transaction request using a browser-compatible interface running on a computer system.

23. A system for making an international payment from a source account in a first country to a local currency account in another, second country, comprising:
means for creating a payment instruction and a payment request that are associated with a common transaction request;
means for communicating the payment instruction to the local currency account in the second country;
wherein the payment instruction designates a beneficiary account in the second country for the local currency account to transfer currency to; and
means for communicating the payment request to a funds source associated with the source account; wherein:
in accordance with the payment request, funds are transferred from the funds source to a treasury account if necessary to maintain a balance at the treasury account which is sufficient to cover an amount of the payment request, and funds at the treasury account are used to provide at least one of: (a) a payment to, and (b) a credit entry on behalf of, the local currency account in a currency of the second country.

24. A computerized system for making an international payment from a source account in a first country to a local currency account in another, second country, comprising:
a computerized system in the first country for creating a payment instruction and a payment request that are associated with a common transaction request, communicating the payment instruction to the local currency account in the second country, and communicating the payment request to a funds source associated with the source account; wherein:
the payment instruction designates a beneficiary account in the second country for the local currency account to transfer currency to; and
in accordance with the payment request, funds are transferred from the funds source to a treasury account if necessary to maintain a balance at the treasury account which is sufficient to cover an amount of the payment request, and funds at the treasury account are used to provide at least one of: (a) a payment to, and (b) a credit entry on behalf of, the local currency account in a currency of the second country.

25. A method for providing a customized international payment transaction user interface, comprising:
during an initialization access session of an international payment transaction system by a user, receiving, via a computerized user interface, information from a user for identifying the user and for identifying at least one account from which funds may be drawn when an international payment transaction is executed;
creating a record having the information for identifying the user and for identifying the at least one account; and
assigning an identifier for the record to enable retrieval of the record for customizing the computerized user interface to enable the user to make an international payment transaction upon a subsequent access of the system by the user.

26. The method of claim 25, wherein:
the customized computerized user interface enables the user to make an international payment transaction without having to re-enter the information for identifying the at least one account.

27. The method of claim 25, further comprising:
communicating with an institution at which the account is held to verify the at least one account.

28. The method of claim 25, further comprising:
communicating with a credit-reporting bureau to obtain an indication of a credit worthiness of the user.
